(19) United States
(12) Patent Application Publication
(10) Pub. No.: US 2019/0280892 A1
(43) Pub. Date: Sep. 12, 2019

(54) IN-VEHICLE COMMUNICATION DEVICE

(71) Applicant: TOYOTA JIDOSHA KABUSHIKI KAISHA, Toyota-shi (JP)

(72) Inventors: Atsushi IWATA, Toyota-shi (JP); Nobuyuki NAKAGAWA, Toyota-shi (JP); Yoshitaka KASEDA, Toyota-shi (JP); Naoki ADACHI, Toyota-shi (JP)

(73) Assignee: TOYOTA JIDOSHA KABUSHIKI KAISHA, Toyota-shi (JP)

(21) Appl. No.: 16/242,330

(22) Filed: Jan. 8, 2019

(30) Foreign Application Priority Data
Mar. 8, 2018 (JP) 2018-041899

(51) Int. Cl. H04L 12/40; H04L 12/863

(52) U.S. Cl. CPC H04L 12/40; H04L 2012/40273; H04L 47/6215

(57) ABSTRACT

An in-vehicle communication device that includes: an addition unit that adds a frame to be relayed to an external tool connection bus to a relay table in which targets for relay processing are registered; a judgment unit that judges, when the frame is added to the relay table, whether or not relay processing is delayed after execution of the relay processing is started; and an elimination unit that eliminates the frame from the relay table when it is judged that the relay processing is delayed.

### CROSS-REFERENCES TO RELATED APPLICATION

This application relates to and claims priority from Japanese Patent Application No. 2018-041899, filed on Mar. 8, 2018, the entire disclosure of which is incorporated herein by reference.

### BACKGROUND

### Field

The present invention relates to an in-vehicle communication device.

### Description of Related Art

Recent automobiles are each equipped with a plurality of microcomputers called ECUs (Electronic Control Units). These ECUs control operations of automobiles by communicating data with each other.

For example, JP2015-039924 A discloses an in-vehicle network system that includes a plurality of in-vehicle networks connected to a plurality of in-vehicle electronic control units, the plurality of in-vehicle networks being connected to each other via a gateway, wherein only a first in-vehicle network has a connector capable of being connected to an external device outside the in-vehicle network system; wherein, when the gateway receives a transfer request from the external device outside the in-vehicle network system via the connector, the gateway transfers as-is communication data within a second in-vehicle network to the first in-vehicle network.

However, in such in-vehicle network system, while the communication data within the second in-vehicle network is transferred as-is to the first in-vehicle network, the execution of relay processing by the gateway is delayed.

### SUMMARY

An object of the present invention is to provide an in-vehicle communication device capable of alleviating a state in which relay processing is delayed.

An in-vehicle communication device according to an aspect of the invention includes: an addition unit that adds a frame to be relayed to an external tool connection bus to a relay table in which targets for relay processing are registered; a judgment unit that judges, when the frame is added to the relay table, whether or not relay processing is delayed after execution of the relay processing is started; and an elimination unit that eliminates the frame from the relay table when it is judged that the relay processing is delayed.

An in-vehicle communication device according to another aspect of the invention includes: an addition unit that adds a frame to be relayed to an external tool connection bus to a relay table in which targets for relay processing are registered; a judgment unit that judges, when the frame is added to the relay table, whether or not relay processing will be delayed before execution of the relay processing is started; and an elimination unit that eliminates the frame from the relay table before the execution of the relay processing is started, when it is judged that the relay processing will be delayed.

### BRIEF DESCRIPTION OF DRAWINGS

FIG. 1 is a diagram showing an in-vehicle communication device, buses, ECUs, an external tool connection bus and an external tool, as well as how they connect to each other, according to a first embodiment.

FIG. 2 is a diagram showing an example of a configuration of the in-vehicle communication device according to the first embodiment.

FIG. 3 is a diagram showing an example of a relay table according to the first embodiment.

FIG. 4 is a flow chart showing an example of processes executed by the in-vehicle communication device according to the first embodiment.

FIG. 5 is a diagram showing an example of a configuration of an in-vehicle communication device according to a second embodiment.

FIG. 6 is a diagram showing an example of a relay table according to the second embodiment.

FIG. 7 is a flow chart showing an example of processes executed by the in-vehicle communication device according to the second embodiment.

FIG. 8 is a diagram showing an example of a configuration of an in-vehicle communication device according to a third embodiment.

FIG. 9 is a diagram showing an example of a load for each bus calculated by the in-vehicle communication device according to the third embodiment.

FIG. 10 is a flow chart showing an example of processes executed by the in-vehicle communication device according to the third embodiment.

### DETAILED DESCRIPTION

Preferred embodiments of the present invention will now be described with reference to the attached drawings. In each drawing, like reference numerals denote the same or similar configurations.

### First Embodiment

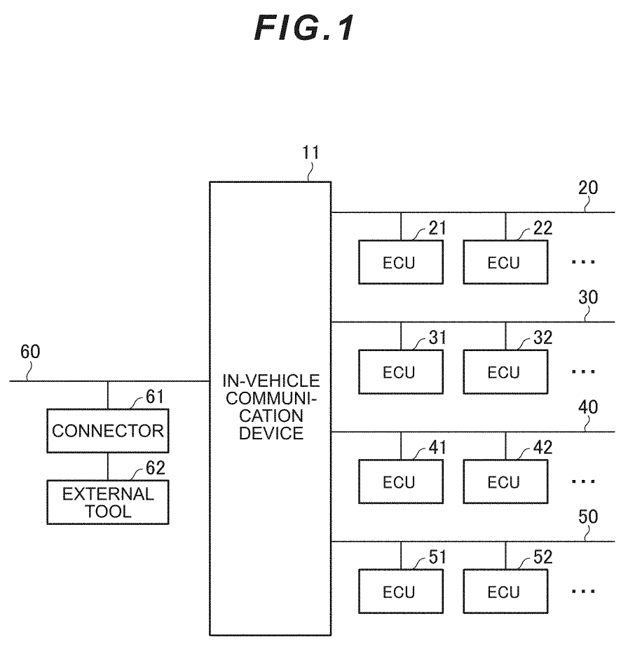

An in-vehicle communication device according to a first embodiment will now be described with reference to FIGS. 1-3.

As shown in FIG. 1, an in-vehicle communication device 11 is connected to a bus 20, a bus 30, a bus 40 and a bus 50 so as to be communicable with each other, the buses being for use in transmitting and receiving frames for allowing components of an automobile to cooperate with each other. The bus 20 is connected to an ECU 21, an ECU 22, and so on, which control the respective components of the automobile so as to be communicable with each other. Similarly, the bus 30 is connected to ECU31, ECU 32, and so on, so as to be communicable with each other, and the bus 40 is connected to ECU 41, ECU 42, and so on, so as to be communicable with each other, and the bus 50 is connected to ECU 51, ECU 52, and so on, so as to be communicable with each other. Examples of communication protocols employed by these buses may include LIN (Local Interconnect Network), CAN (Controller Area Network), or an in-vehicle Ethernet (registered trademark).

The in-vehicle communication device 11 is further connected to an external tool connection bus 60 so as to be communicable with each other.

The external tool connection bus 60 is connected to an external tool 62 via a connector 61. The external tool 62 is a device for inspecting whether or not the content indicated by a frame relayed by the in-vehicle communication device 11, the timing at which the frame is transmitted, the timing at which the frame is received, an ECU for transmitting the frame and an ECU for receiving the frame are appropriate. Alternatively, the external tool 62 may be directly connected to the external tool connection bus 60 rather than via the connector 61. The external tool 62 may, for example, be connected to the external tool connection bus 60 when a program of any ECU shown in FIG. 1 is updated or when the automobile is repaired. It should be noted that the external tool connection bus 60 may be connected to an ECU so as to be communicable with each other.

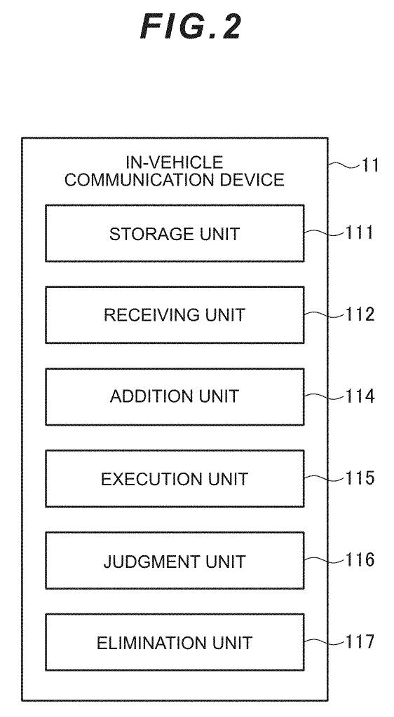

As shown in FIG. 2, the in-vehicle communication device 11 may include, for example, a storage unit 111, a receiving unit 112, an addition unit 114, an execution unit 115, a judgment unit 116 and an elimination unit 117, and may be implemented by, for example, a gateway ECU. The in-vehicle communication device 11 is only required to include at least the addition unit 114, the judgment unit 116 and the elimination unit 117, and may include additional components other than those shown in FIG. 2. The in-vehicle communication device 11 may use, instead of at least one of its components, another device having a similar function.

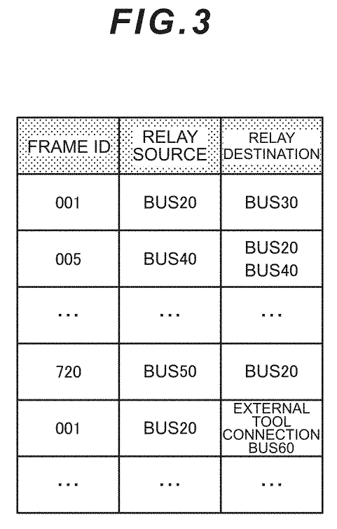

The storage unit 111 is a storage medium storing a relay table in which targets of relay processing (frames to be relayed) are registered. The relay processing herein refers to processing in which the in-vehicle communication device 11 receives a frame from a bus in a relay source and sends the frame to a bus in a relay destination. The relay table indicates an ID unique to each frame, a relay source of each frame and a relay destination of each frame. For example, the second row from the top of the relay table in FIG. 3 indicates that the relay source of ID “005” is the bus 40 and that the relay destinations thereof are the bus 20 and the bus 40. The other rows of the relay table in FIG. 3 each have similar content.

The receiving unit 112 receives, from the external tool 62, a signal requesting the in-vehicle communication device 11 to add a frame to be relayed to the external tool communication bus 60 to the relay table. The signal may be transmitted or received for each frame. The receiving unit 112 may also receive, from the external tool 62, a signal requesting a stop in the relay processing of the frame added to the relay table.

The addition unit 114 adds the frame to be relayed to the external tool connection bus 60 to the relay table in which targets for relay processing are registered. For example, the addition unit 114 adds a frame with ID “001,” shown in the 6^{th} row from the top of the table in FIG. 3 to the relay table, as a frame to be relayed from the bus 20 to the external tool communication bus 60, in accordance with a signal received by the receiving unit 112.

The execution unit 115 executes relay processing in accordance with the relay table. For example, the execution unit 115 relays a frame with ID “720” from the bus 50 to the bus 20 as shown in the 5^{th} row from the top of the table in FIG. 3, and relays a frame with ID “001” from the bus 20 to the external tool connection bus 60 as shown in the 6^{th} row from the top of the table in FIG. 3.

When a frame is added to the relay table, the judgment unit 116 judges whether or not relay processing is delayed after the execution of the relay processing is started. Specifically, when the time required for relay processing of a given frame exceeds a predetermined threshold value, the judgment unit 116 judges that the relay processing is delayed. The threshold value is expressed as a percentage of a delay relative to a transmission cycle which has been set for each frame. Alternatively, the judgment unit 116 may judge that relay processing is delayed when a given frame is overwritten while the relay processing for the given frame is being executed. When the number or data size of frames which are being relayed by the in-vehicle communication device 11 is large, such delay or overwrite may occur and a frame may be discarded during the relay processing in such case. Although the given frame in the above examples is at least one of the frames shown in the 2^{nd} to 5^{th} rows from the top of the table in FIG. 3, it may include any frame shown in the 6^{th} to 7^{th} rows from the top of the table in FIG. 3.

The judgment unit 116 further judges whether or not the receiving unit 112 has received, from the external tool 62, a signal requesting a stop in the relay processing of the frame added to the relay table.

When it has been judged that the relay processing is delayed, the elimination unit 117 eliminates the frame to be relayed to the external tool connection bus 60 from the relay table. For example, when it is judged that the relay processing is delayed, the elimination unit 117 eliminates the frame with ID “001” shown in the 6^{th} row from the top of the table in FIG. 3 from the relay table.

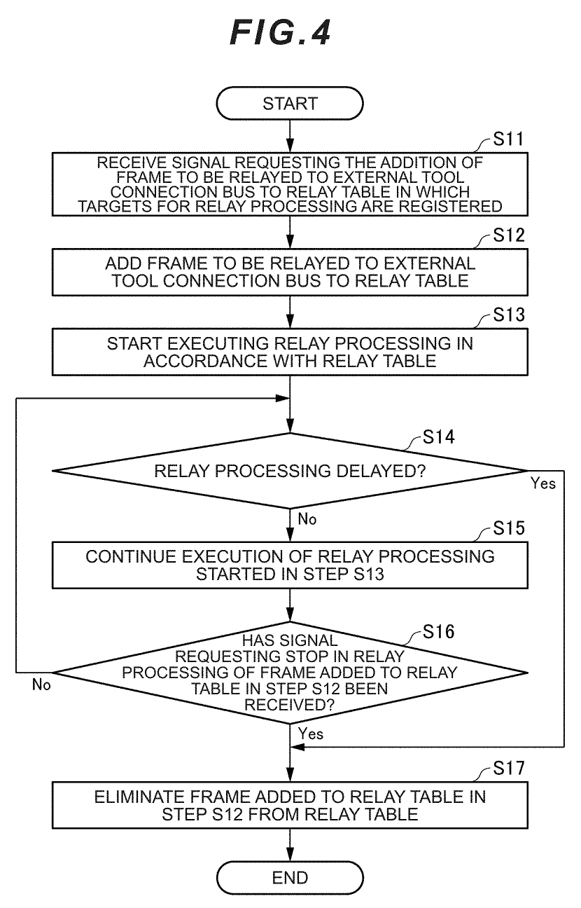

Next, a preferred example of processes executed by the in-vehicle communication device 11 according to the first embodiment will now be described below with reference to FIG. 4.

In step S11, the receiving unit 112 receives a signal requesting the addition of a frame to be relayed to the external tool connection bus 60 to the relay table in which targets for relay processing are registered.

In step S12, the addition unit 114 adds the frame to be relayed to the external tool connection bus 60 to the relay table.

In step S13, the execution unit 115 starts executing relay processing in accordance with the relay table.

In step S14, the judgment unit 116 judges whether or not the relay processing is delayed. When judging that the relay processing is delayed (step S14: Yes), the judgment unit 116 moves the process to step S17, while when judging that the relay processing is not delayed (step S14: No), the judgment unit 116 moves the process to step S15.

In step S15, the execution unit 115 continues the execution of the relay processing that was started in step S13.

In step S16, the judgment unit 116 judges whether or not a signal requesting a stop in the relay processing of the frame added to the relay table in step S12 has been received. When judging that such signal has been received (step S16: Yes), the judgment unit 116 moves the process to step S17, while when judging that such signal has not been received (step S16: No), the judgment unit 116 moves the process back to step S14.

In step S17, the elimination unit 117 eliminates the frame added to the relay table in step S12 from the relay table.

The first embodiment, being one example of the invention, has been described above. The in-vehicle communication device 11 according to the first embodiment judges whether or not relay processing is delayed based on the result of actual execution of the relay processing and, when judging that the relay processing is delayed, eliminates the frame to be relayed to the external tool connection bus 60 from the relay table. With such configuration, the in-vehicle communication device 11 can alleviate the delayed state of the relay processing without needing to take into consideration static information, such as the data length, transmission cycle and protocol, of the fame to be relayed.

### Second Embodiment

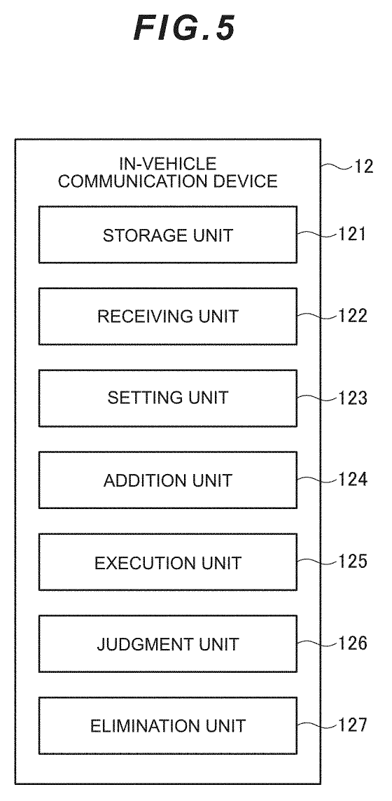

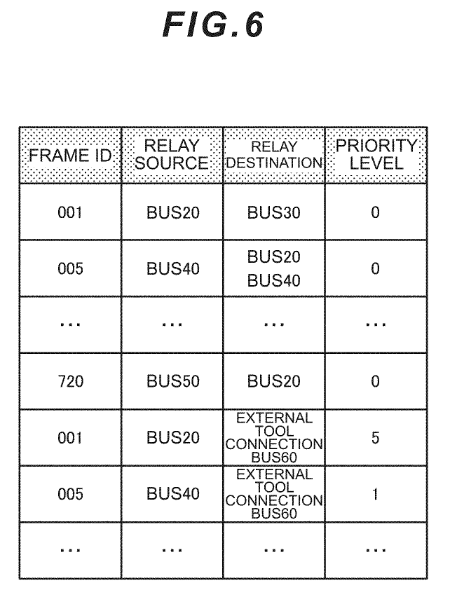

An in-vehicle communication device according to a second embodiment will now be described below with reference to FIGS. 5 and 6. It should be noted that redundant descriptions which have already been described in the first embodiment will be omitted in the second embodiment.

As shown in FIG. 5, an in-vehicle communication device 12 includes a storage unit 121, a receiving unit 122, a setting unit 123, an addition unit 124, an execution unit 125, a judgment unit 126 and an elimination unit 127. The in-vehicle communication device 12 is only required to include at least the addition unit 124, the judgment unit 126 and the elimination unit 127.

The storage unit 121, the receiving unit 122, the addition unit 124, the execution unit 125 and the judgment unit 126 are similar to the storage unit 111, the receiving unit 112, the addition unit 114, the execution unit 115 and the judgment unit 116, respectively, of the first embodiment.

The setting unit 123 sets a priority level of relay processing for frames to be relayed to the external tool connection bus 60. For example, the setting unit 123 sets priority level “5” for a frame with ID “001” shown in the 6^{th} row of the table in FIG. 6 and sets priority level “1” for a frame with ID “005” shown in the 7^{th} row of the table in FIG. 6. In this embodiment, frames with a lower number of priority level will be subjected to the relay processing to the external connection bus 60 with a higher priority. It should be noted that, as shown in the 2^{nd} row to 5^{th} row from the top of the table in FIG. 6, priority level “0” is set for frames to be relayed to busses other than the external tool connection bus 60.

When it is judged that the relay processing is delayed, the elimination unit 127 eliminates from the relay table a frame(s) having a priority level equal to or lower than a threshold value from among the frames for which a priority level has been set. For example, the elimination unit 127 eliminates, from the relay table shown in FIG. 6, the frame with the ID “001” having a priority level equal to or higher than the predetermined threshold value “5,” from among the frames shown in the 6^{th} row to 8^{th} row from the top of the table shown in FIG. 6.

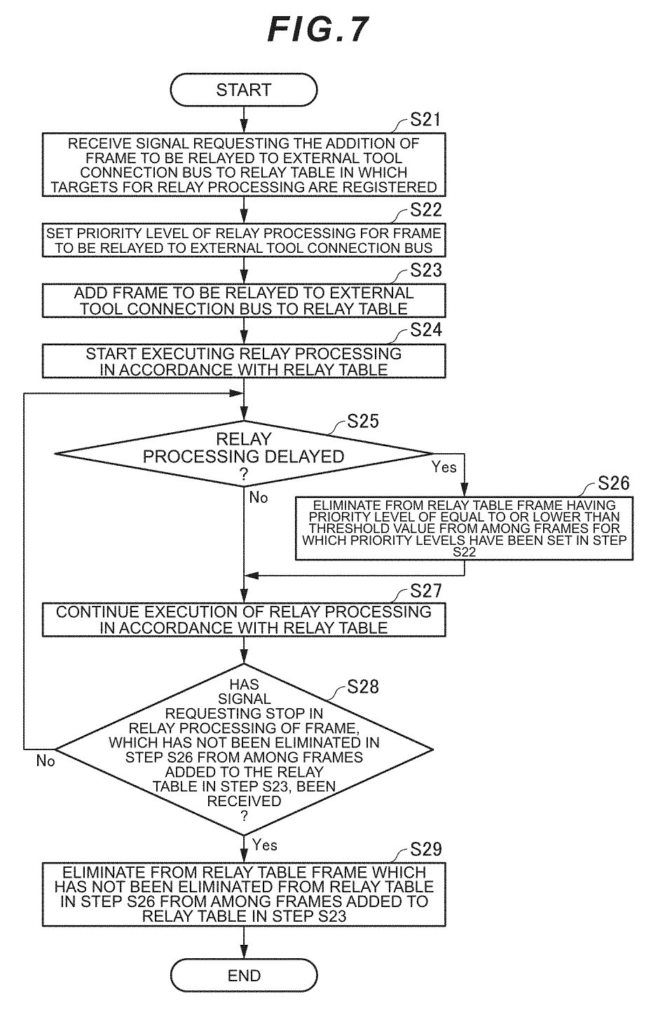

Next, a preferred example of processes executed by the in-vehicle communication device according to the second embodiment will be described below with reference to FIG. 7.

In step S21, the receiving unit 122 receives a signal requesting the addition of a frame to be relayed to the external tool connection bus 60 to the relay table in which targets for relay processing are registered.

In step S22, the setting unit 123 sets a priority level of relay processing for the frame to be relayed to the external tool connection bus 60.

In step S23, the addition unit 124 adds the frame to be relayed to the external tool connection bus 60 to the relay table.

In step S24, the execution unit 125 starts executing relay processing in accordance with the relay table.

In step S25, the judgment unit 126 judges whether or not the relay processing is delayed. When judging that the relay processing is delayed (step S25: Yes), the judgment unit 126 moves the process to step S26, while when judging that the relay processing is not delayed (step S25: No), the judgment unit 126 moves the process to step S27.

In step S26, the elimination unit 127 eliminates from the relay table a frame having a priority level equal to or lower than the threshold value from among the frames for which priority levels have been set in step S22.

In step S27, the execution unit 125 continues the execution of the relay processing in accordance with the relay table.

In step S28, the judgment unit 126 judges whether or not a signal requesting a stop in the relay processing of the frame, which has not been eliminated in step S26 from among the frames added to the relay table in step S23, has been received. When judging that such signal has been received (step S28: Yes), the judgment unit 126 moves the process to step S29, while when judging that such signal has not been received (step S28: No), the judgment unit 116 moves the process back to step S25.

In step S29, the elimination unit 127 eliminates from the relay table the frame which has not been eliminated from the relay table in step S26 from among the frames added to the relay table in step S23.

It should be noted that the in-vehicle communication device 12 may execute the above-mentioned processes with step S22 and step S23 exchanged with each other.

The second embodiment, being one example of the invention, has been described above. The in-vehicle communication device 12 according to the second embodiment sets the priority levels of relay processing for the frames to be relayed to the external tool connection bus 60 and eliminates a frame with a priority level equal to or lower than the threshold value from the relay table. With such configuration, the in-vehicle communication device 12 can alleviate the delayed state of the relay processing while continuing to relay frames to the external tool communication bus 60 as far as possible, which is different from the in-vehicle communication device 11 according to the first embodiment.

### Third Embodiment

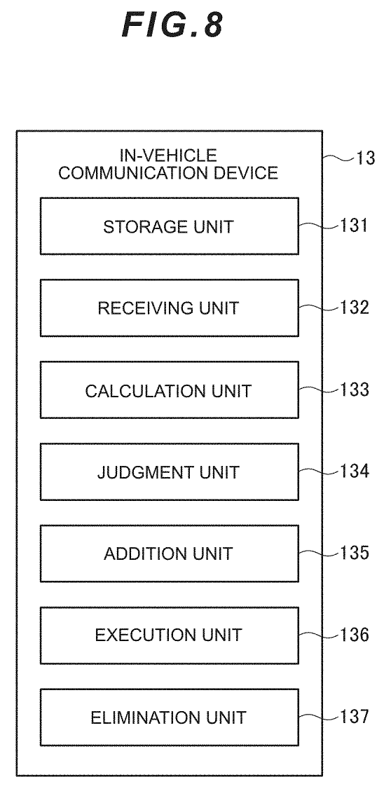

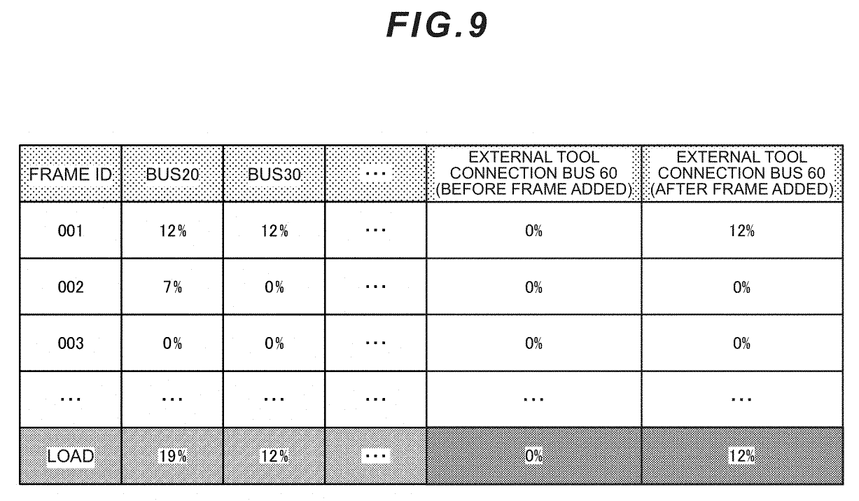

An in-vehicle communication device according to a third embodiment will now be described with reference to FIGS. 8 and 9.

As shown in FIG. 8, an in-vehicle communication device 13 includes a storage unit 131, a receiving unit 132, a calculation unit 133, a judgment unit 134, an addition unit 135, an execution unit 136 and an elimination unit 137.

The in-vehicle communication device 13 is only required to include at least the judgment unit 134, the addition unit 135 and the elimination unit 137.

The storage unit 131, the receiving unit 132, the addition unit 135 and the execution unit 136 are similar to the storage unit 111, the receiving unit 112, the addition unit 114 and the execution unit 115, respectively, of the first embodiment.

The calculation unit 133 calculates a load applied to each of the bus 20, the bus 30, the bus 40, the bus 50 and the external tool connection bus 60 which can be used for transmitting and receiving frames. For example, as shown in the second column from the left of the table in FIG. 9, the calculation unit 133 calculates the sum (19%) of the loads “12%,” “7%,” “0%,” and so on, that the respective frames with the IDs “001,” “002,” “003,” and so on, apply to the bus 20. Further, as shown in the 5^{th} and 6^{th} columns from the left of the table in FIG. 9, when a frame with the ID “001” is added as a frame to be relayed to the external tool connection bus 60, the load calculated by the calculation unit 133 is changed from “0%” to “12%.”

When a frame is added to the relay table, the judgment unit 134 judges whether or not relay processing will be delayed before the execution of the relay processing is started. Specifically, when at least one of the loads to the bus 20, the bus 30, the bus 40, the bus 50 and the external tool connection bus 60 exceeds a predetermined threshold value, the judgment unit 134 judges that the relay processing will be delayed. In such case, these five buses may either be a relay source or a relay destination. For example, when at least one of the load on the bus 20 (19%), the load on the bus 30 (12%), and so on, exceeds the predetermined threshold value, the judgement unit 134 judges that the relay processing will be delayed. Alternatively, the judgment unit 134 may judge that the relay processing will be delayed when the load on the external tool connection bus 60 (12%) exceeds the predetermined threshold value.

When it is judged that the relay processing will be delayed, the elimination unit 137 eliminates from the relay table the frame to be relayed to the external tool connection bus 60 before the execution of the relay processing is started. For example, the frame to be eliminated by the elimination unit 137 is the frame with the ID “001” shown in the 2^{nd} row from the top of the table in FIG. 9.

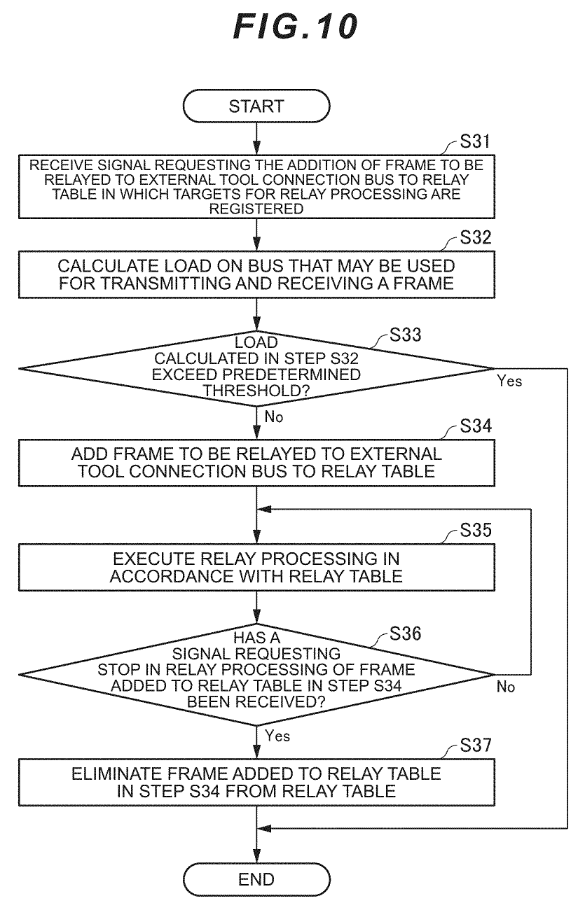

Next, a preferred example of processes executed by the in-vehicle communication device according to the third embodiment will be described below with reference to FIG. 10.

In step S31, the receiving unit 132 receives a signal requesting the addition of a frame to be relayed to the external tool connection bus 60 to the relay table in which targets for relay processing are registered.

In step S32, the calculation unit 133 calculates loads to buses that may be used for transmitting and receiving a frame, such as the bus 20, the bus 30, the bus 40, the bus 50 and the external tool connection bus 60.

In step S33, the judgment unit 134 judges whether or not a load calculated in step S32 exceeds the predetermined threshold. When judging that the load exceeds the predetermined threshold value (step S33: Yes), the judgment unit 134 terminates the process of adding a frame to be relayed, while when judging that the load is equal to or lower than the predetermined threshold value (step S33: No), the judgment unit 134 moves the process to step S34.

In step S34, the addition unit 135 adds the frame to be relayed to the external tool connection bus 60 to the relay table.

In step S35, the execution unit 136 starts executing relay processing in accordance with the relay table.

In step S36, the judgment unit 134 judges whether or not a signal requesting a stop in the relay processing of the frame added to the relay table in step S34 has been received. When judging that such signal has been received (step S36: Yes), the judgment unit 134 moves the process to step S37, while when judging that such signal has not been received (step S36: No), the judgment unit 134 moves the process back to step S35.

In step S37, the elimination unit 127 eliminates from the relay table the frame added to the relay table in step S34.

The third embodiment, being one example of the invention, has been described above. When a frame to be relayed to the external tool connection bus 60 is added to the relay table, the in-vehicle communication device 13 according to the third embodiment judges whether or not relay processing will be delayed before the execution of the relay processing is started. When judging that the relay processing will be delayed, the in-vehicle communication device 13 eliminates the frame which has been added to the relay table from the relay table before the execution of the relay table is started. Accordingly, since the in-vehicle communication device 13 can alleviate the delayed state of the relay processing and it does not have to perform judgment as to whether or not the relay processing will be delayed simultaneously with the execution of the relay processing, it is possible to conserve processing capacity.

The above embodiments have been presented merely as examples and such embodiments are not intended to limit the scope of the invention. Thus, various types of omissions, substitutions and changes may be made to the above embodiments without departing from the gist of the invention. Accordingly, the above embodiments, as well as their various modifications, are included in the scope and gist of the invention.

The invention can provide an in-vehicle communication device capable of alleviating a state in which relay processing is delayed.

What is claimed is:

1. An in-vehicle communication device, comprising:
an addition unit that adds a frame to be relayed to an external tool connection bus to a relay table in which targets for relay processing are registered;
a judgment unit that judges, when the frame is added to the relay table, whether or not relay processing is delayed after execution of the relay processing is started; and
an elimination unit that eliminates the frame from the relay table when it is judged that the relay processing is delayed.

2. The in-vehicle communication device according to claim 1, wherein the judgment unit judges that the relay processing is delayed when time required for the relay processing of a given frame exceeds a predetermined threshold value.

3. The in-vehicle communication device according to claim 1, wherein the judgment unit judges that the relay processing is delayed when a given frame is overwritten while the relay processing for the given frame is being executed.

4. The in-vehicle communication device according to claim 1, wherein:
the judgment unit further includes a setting unit that sets a priority level of relay processing for the frame to be relayed to the external tool connection bus; and
when it is judged that the relay processing is delayed, the elimination unit eliminates from the relay table a frame with a priority level equal to or lower than a predetermined threshold value from among frames for which priority levels have been set.

5. An in-vehicle communication device, comprising:
an addition unit that adds a frame to be relayed to an external tool connection bus to a relay table in which targets for relay processing are registered;
a judgment unit that judges, when the frame is added to the relay table, whether or not relay processing will be delayed before execution of the relay processing is started; and
an elimination unit that eliminates the frame from the relay table before the execution of the relay processing is started, when it is judged that the relay processing will be delayed.

6. The in-vehicle communication device according to claim 5, further comprising a calculation unit that calculates a load on a bus which can be used for transmitting and receiving the frame,
wherein the judgment unit judges that the relay processing will be delayed when the load on the bus exceeds a predetermined threshold value.
